(19) United States
(12) Patent Application Publication
(10) Pub. No.: US 2026/0077717 A1
(43) Pub. Date: Mar. 19, 2026

(54) CAMERA MONITOR SYSTEM INCLUDING TRAILER-MOUNTED CAMERA

(71) Applicant: Stoneridge Electronics AB, Solna (SE)

(72) Inventors: Vamsi Krishna Konka, Novi, MI (US); Banuprakash Murthy, Novi, MI (US); Girikrishna Talla, Novi, MI (US)

(21) Appl. No.: 18/887,340

(22) Filed: Sep. 17, 2024

(51) Int. Cl. B60R 1/22; H04N 7/18; H04N 23/90

(52) U.S. Cl. CPC B60R 1/22; H04N 7/181; H04N 23/90; B60R 2300/105; B60R 2300/802

(57) ABSTRACT

A method for a camera monitor system (CMS) includes utilizing a first camera mounted to a first side of a tractor of a commercial vehicle to obtain a first image feed of an external environment of the commercial vehicle along a first side of a trailer of the commercial vehicle; displaying the first image feed on a first electronic display; and, based on the commercial vehicle having a non-zero trailer angle that causes the first side of the trailer to be outside a field of view of the first camera, commence displaying a second image feed from a second camera on the first electronic display or another electronic display. The second camera is mounted to the trailer. The second image feed is of the external environment of the commercial vehicle along the first side of the trailer. A camera monitor system (CMS) is also disclosed.

### TECHNICAL FIELD

This disclosure relates to a camera monitor system (CMS), and more particularly to a CMS and method that utilizes a trailer-mounted camera.

### BACKGROUND

Vehicle camera systems for mirror replacement or for supplementing mirror views are utilized in commercial vehicles to enhance the ability of a vehicle operator to see a surrounding environment of the commercial vehicle. These systems are known as “camera monitor systems” (CMS), and they utilize one or more cameras mounted to a tractor of a commercial vehicle to provide an enhanced field of view to a vehicle operator of an area surrounding a trailer of the commercial vehicle. CMS may also include cameras in locations not typically associated with a mirror, such as a rear camera (e.g., a trailer camera) that records images of an area behind a vehicle, a camera that records an area in front of a vehicle, etc.

An issue facing both CMS and traditional mirror systems is that during turns (e.g., backup turns) of a sufficient magnitude, one side of the trailer becomes obstructed by the tractor, reducing visibility along that side of the trailer.

### SUMMARY

A method for a camera monitor system (CMS) according to an example embodiment of the present disclosure includes utilizing a first camera mounted to a first side of a tractor of a commercial vehicle to obtain a first image feed of an external environment of the commercial vehicle along a first side of a trailer of the commercial vehicle; displaying the first image feed on a first electronic display; and, based on the commercial vehicle having a non-zero trailer angle that causes the first side of the trailer to be outside a field of view of the first camera, commence displaying a second image feed from a second camera on the first electronic display or another electronic display. The second camera is mounted to the trailer. The second image feed is of the external environment of the commercial vehicle along the first side of the trailer.

In a further embodiment of the foregoing embodiment, the second camera is mounted to the first side of the trailer.

In a further embodiment of any of the foregoing embodiments, the commence displaying the first image feed from the second camera is further based on the commercial vehicle being in reverse.

In a further embodiment of any of the foregoing embodiments, the commence displaying the first image feed from the second camera is further based on the non-zero trailer angle being at least 10°.

In a further embodiment of any of the foregoing embodiments, the second camera is mounted to the trailer at a location that is closer to a front of the trailer than to a rear of the trailer.

In a further embodiment of any of the foregoing embodiments, the commence displaying the first image feed from the second camera includes commence displaying the second image feed on a second electronic display that is different from the first electronic display.

In a further embodiment of any of the foregoing embodiments, the commence displaying the first image feed from the second camera includes commence displaying the second image feed on the first electronic display.

In a further embodiment of any of the foregoing embodiments, the method includes utilizing a third camera mounted to a second side of the tractor of the commercial vehicle to obtain a third image feed of an external environment of the commercial vehicle along the second side of the trailer. The second side of the trailer is opposite to the first side of the trailer. The method also includes displaying the third image feed on a second electronic display and, based on the commercial vehicle having a non-zero trailer angle that causes the second side of the trailer to be outside a field of view of the second camera, commence displaying a fourth image feed from a fourth camera on the second electronic display or another electronic display. The fourth camera is mounted to the trailer. The fourth image feed is of the external environment of the commercial vehicle along the second side of the trailer.

A camera monitor system (CMS) according to an example embodiment of the present disclosure includes a first camera mounted to a first side of a tractor of a commercial vehicle and configured to provide a first image feed of an external environment of the commercial vehicle along a first side of a trailer of the commercial vehicle; a second camera mounted to the trailer and configured to provide a second image feed of the external environment along the first side of the trailer; and processing circuitry operatively connected to memory. The processing circuitry is configured to display the first image feed on a first electronic display and, based on the commercial vehicle having a non-zero trailer angle that causes the first side of the trailer to be outside a field of view of the first camera, commence display of the second image feed on the first electronic display or another electronic display.

In a further embodiment of the foregoing embodiment, the second camera is mounted to the first side of the trailer.

In a further embodiment of any of the foregoing embodiments, the processing circuitry is configured to further base the commencement of display of the second image feed on the commercial vehicle being in reverse.

In a further embodiment of any of the foregoing embodiments, the processing circuitry is configured to further base the commencement of display of the second image feed on the non-zero trailer angle being at least 10°.

In a further embodiment of any of the foregoing embodiments, the second camera is mounted to the trailer at a location that is closer to a front of the trailer than to a rear of the trailer.

In a further embodiment of any of the foregoing embodiments, to commence display of the second image feed, the processing circuitry is configured to display the second image feed on a second electronic display that is different from the first electronic display.

In a further embodiment of any of the foregoing embodiments, to commence display of the second image feed, the processing circuitry is configured to display the second image feed on the first electronic display.

In a further embodiment of any of the foregoing embodiments, the second camera is part of a second camera arm that is rotatable between a first, retracted position, and a second, extended position.

In a further embodiment of any of the foregoing embodiments, a third camera is mounted to a second side of the tractor and is configured to provide a third image feed of the external environment of the commercial vehicle along a second side of a trailer of the commercial vehicle. The second side of the trailer is opposite to the first side of the trailer. A fourth camera mounted to the trailer is configured to provide a fourth image feed of the external environment along the second side of the trailer. The processing circuitry is configured to, based on the commercial vehicle having a non-zero trailer angle that causes the second side of the trailer to be out of a field of view of the third camera, commence displaying a fourth image feed from the fourth camera on the second electronic display or another electronic display, wherein the fourth image feed is of the external environment of the commercial vehicle along the second side of the trailer.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial vehicle with a camera monitor system (CMS) used to provide at least Class Il and Class IV views.

FIG. 2 is a schematic birds-eye view of the commercial vehicle of FIG. 1 with a CMS providing Class II, Class IV, Class V, Class VI, and Class VIII views.

FIG. 3 is an example schematic birds-eye view of the commercial vehicle of FIG. 1 that shows respective fields of view of two trailer cameras.

FIG. 4 is a schematic birds-eye view of another example trailer camera configuration that includes two trailer cameras.

FIG. 5 is a schematic top view of an example vehicle cabin interior.

FIG. 6 is a perspective view of the vehicle cabin interior of FIG. 3.

FIG. 7A is a schematic birds-eye view of a first example trailer angle.

FIG. 7B is a schematic birds-eye view of a second example trailer angle.

FIG. 8 is a flowchart of an example method for a CMS.

### DETAILED DESCRIPTION

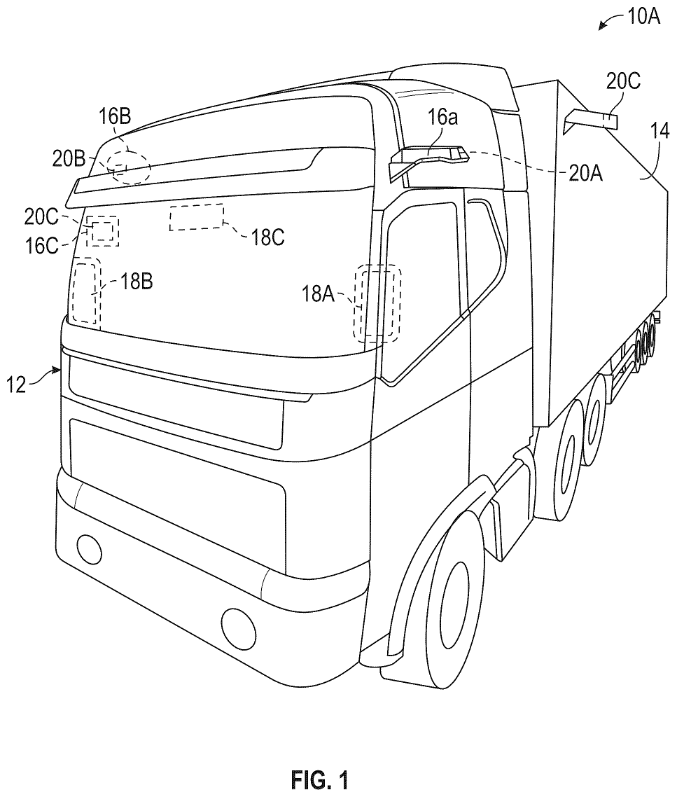

Schematic views of a commercial vehicle 10 are illustrated in FIGS. 1-6. The commercial vehicle 10 includes a vehicle cab or “tractor” 12 for pulling a trailer 14, where the trailer 14 pivots with respect to the tractor 12 during turns. Although the commercial vehicle 10 is depicted as a commercial truck with a single trailer in this disclosure, it is understood that other commercial vehicle configurations may be used (e.g., different types or quantities of trailers).

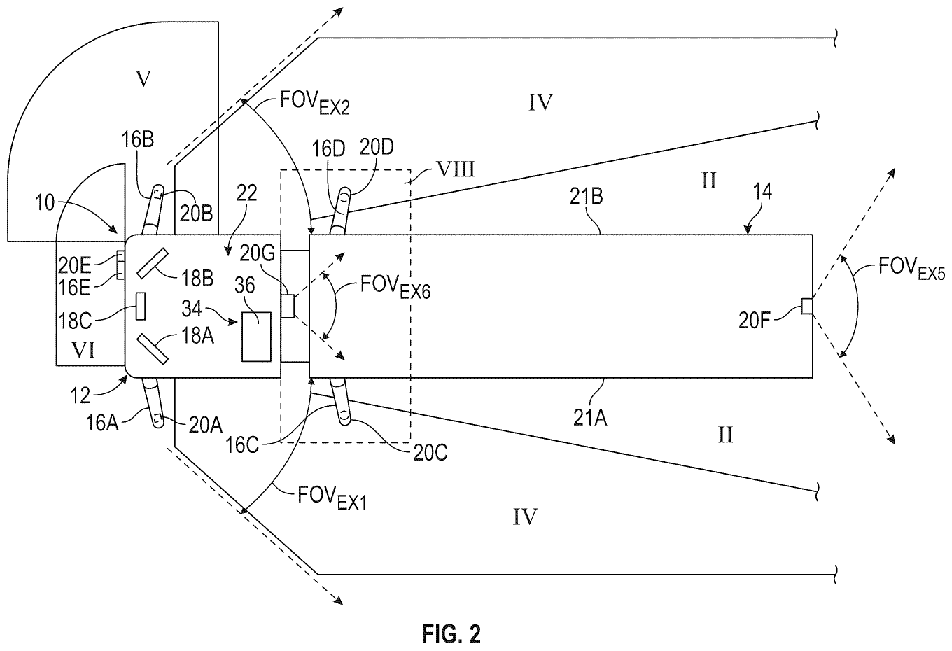

A pair of camera arms 16A-B include a respective base that is secured to the tractor 12, and a pair of camera arms 16C-D include a respective base that is secured to the trailer 14. One, all, or a subset of the camera arms 16A-D may articulate relative to their base between a retracted position and an extended position (shown in FIG. 2). Each camera arm 16A-D includes at least one respective rearward facing camera 20A-D on or within the arm. The cameras 20A-D are at least partially “rearward facing” in that their respective fields of view at least partially face towards a rear of the commercial vehicle 10. The exterior cameras 20A-B respectively provide an exterior field of view FOV_{EX1}, FOV_{EX2} that each include at least one of Class II and Class IV views (see FIG. 2), which are legally prescribed views in the commercial trucking industry. The exterior cameras 20C-D respectively provide an exterior field of view FOV_{EX3}, FOV_{EX4} that have some overlap with the Class II and Class IV views.

As shown in FIG. 2, the trailer 14 has a first side 21A and an opposite second side 21B. When the commercial vehicle 10 is driving straight as in FIG. 2), camera 20A provides a view of along side 21A of the trailer 14, and camera 20B provides a view along side 21B of the trailer.

The Class II view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting, but rather is intended as an example of the type of view provided to a display from a particular camera.

Each camera arm 16A-16D may also provide a housing that encloses electronics, e.g., a controller, that are configured to provide various features of the CMS 15. The camera arms 16A-B may be mounted either at a roof-mount location over the cab door (as shown), or on a door-mounted bracket or station, for example. Similarly, the camera arms 16C-D may be mounted at a roof-mount location of the trailer 14, for example.

If video of Class V and/or Class VI views is also desired, a camera housing 16E and camera 20E may be arranged at or near the front of the commercial vehicle 10 to provide those views (FIG. 2).

A backup camera 20F provides a field of view FOV_{EX5} of rear area 28C behind the commercial vehicle 10, which overlaps the fields of view FOV_{EX1}, FOV_{EX2}, FOV_{EX3A}, FOV_{EX4A}. The backup camera 20F may be mounted at a top/centerline of the trailer, at a bumper/bed level of the trailer, or at a top-corner of the back of the trailer, for example.

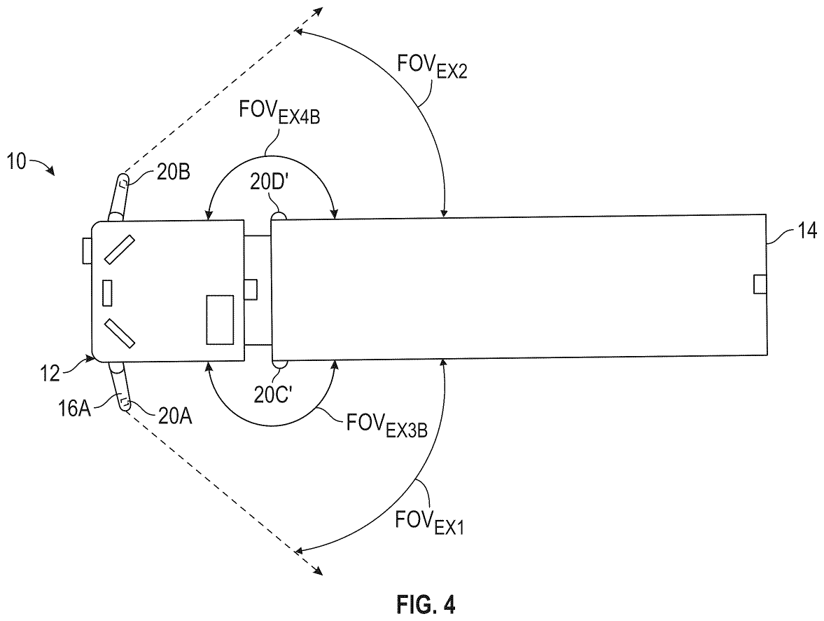

Alternatively, or in addition to the rear trailer camera, a “fifth wheel camera”20G may be provided that is mounted to a rear of the tractor 12 and that provides a field of view FOV_{EX6} which, when the trailer 14 is disconnected from the cab 12, also overlaps the fields of view FOV_{EX1}, FOV_{EX2}, FOV_{EX3A}, FOV_{EXA}. The fifth wheel camera 20G may be mounted anywhere between the lateral plane of the fifth wheel fixture and the top/roof edge of the tractor, for example. The cameras 20A-G are part of a camera monitor system (CMS) 15 (see FIG. 4).

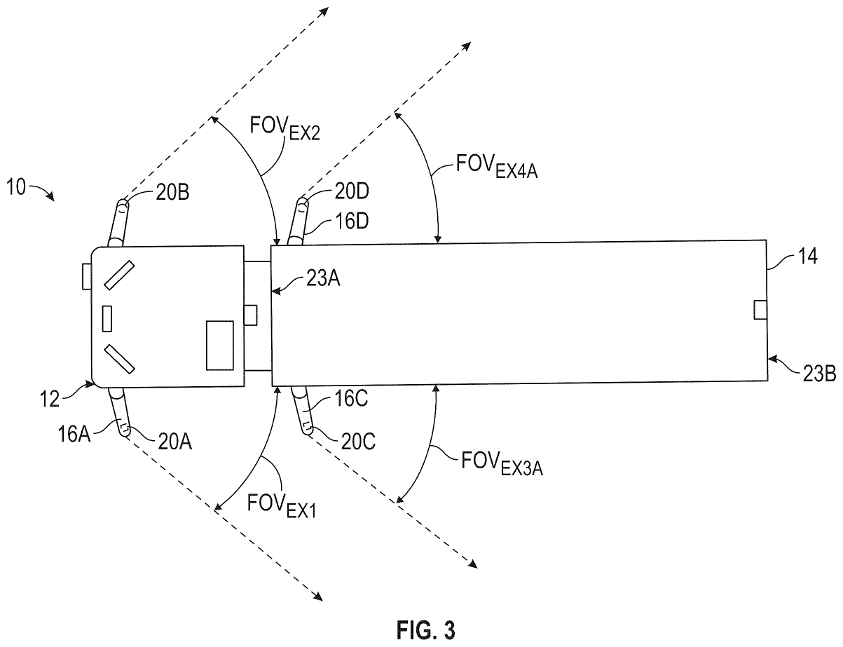

FIG. 3 is a schematic birds-eye view of the commercial vehicle 10 of Figure that shows the fields of view FOV_{EX3A}, FOV_{EX4A} of the trailer cameras 20C-D. As shown, the exterior cameras 20C-D respectively provide an exterior field of view FOV_{EX3A}, FOV_{EX4A} that have some overlap with the Class II and Class IV views shown in FIG. 2. Also, as shown, the exterior cameras 20C-D are mounted to the trailer 14 at respective locations that are closer to a front 23A of the trailer 14 than to a rear 23B of the trailer 14.

FIG. 4 is a schematic birds-eye view of another example trailer camera configuration in which trailer cameras 16C′ and 16D′, having respective fields of view FOV_{EX3B} and FOV_{EX4B}, which are wider angle fields of view than the corresponding fields of view FOV_{EX3A}, FOV_{EX4A} of cameras 16C and 16D. However, it is understood that the trailer cameras 16C′ and 16D′ could have narrower fields of view if desired. Unless stated otherwise, it is understood that camera 16C and 16C′ could be used interchangeably, and that cameras 16D and 16D′ could be used interchangeably.

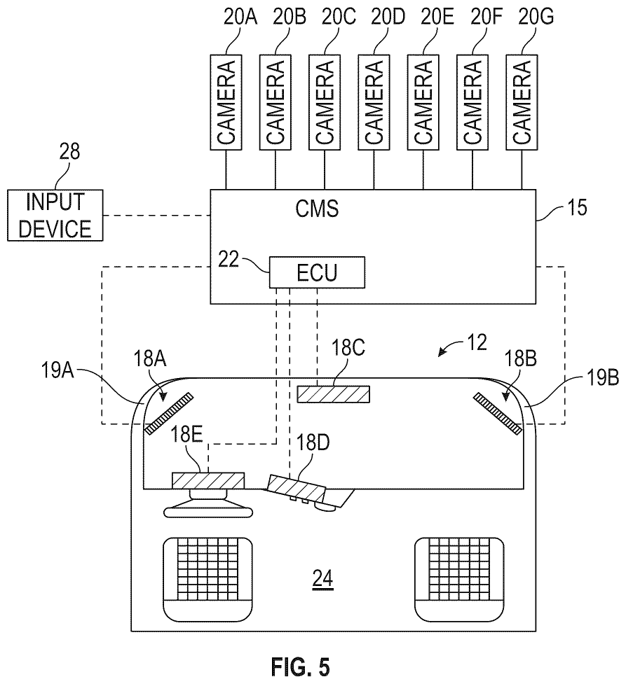

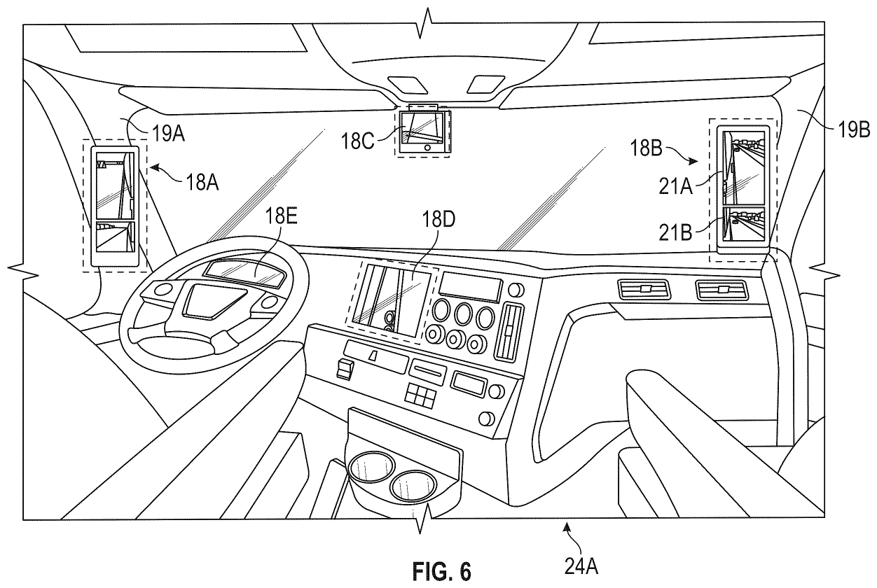

FIG. 5 is a schematic top view of an example vehicle cabin interior 24, and FIG. 6 is a perspective view of the vehicle cabin interior 24. Referring now to FIGS. 4-5 with continued reference to FIGS. 1-3, electronic displays 18A-E (e.g., which may be video displays, such as LCD displays) and cameras 20A-G are shown. The various electronic displays 18A-E and cameras 20A-G are part of the CMS 15, and therefore act as CMS displays and CMS cameras. As used herein, a “CMS camera” 20 is a camera configured to record images of an environment surrounding commercial vehicle 10, and a “CMS display” 18 is an electronic display (e.g., an LCD) that is configured to display image feeds from those cameras.

The CMS 15 includes a CMS electronic control unit (ECU) 22 that acts as a controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rearward facing side views along the commercial vehicle 10 that are captured by the exterior cameras 20A-B.

As discussed above, if video of Class V and Class VI views is also desired, the camera housing 16E and camera 20E may be arranged at or near the front of the commercial vehicle 10 to provide those views (FIG. 2). In the example of FIG. 5, additional displays 18C-E are provided. Display 18C is arranged in the vehicle cabin interior 24 near the top center of the windshield may be used to display the Class V and Class VI views, which are toward the front of the commercial vehicle 10, or a backup camera view (from camera 20F or 20G) to the driver. Display 18D is provided in a center console area of the vehicle cabin interior 24, and may be used as a backup display or for other purposes, such as navigation, infotainment, etc. Display 18E may be part of an instrument cluster, for example, and may be used as a backup display.

If desired, one or more of the camera arms 16A-D may include conventional mirrors integrated with them as well, although the CMS 15 may be used to entirely replace mirrors. In additional examples, each side can include multiple camera arms, with each arm housing one or more cameras and/or mirrors.

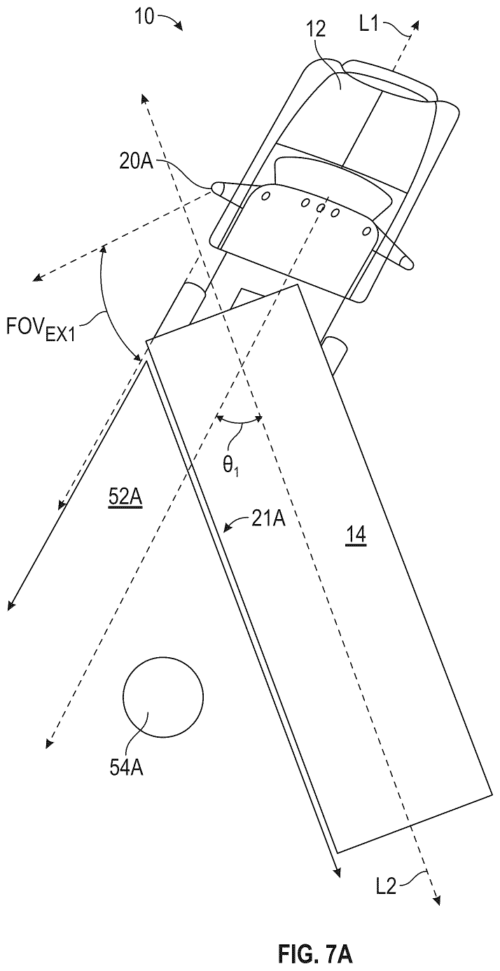

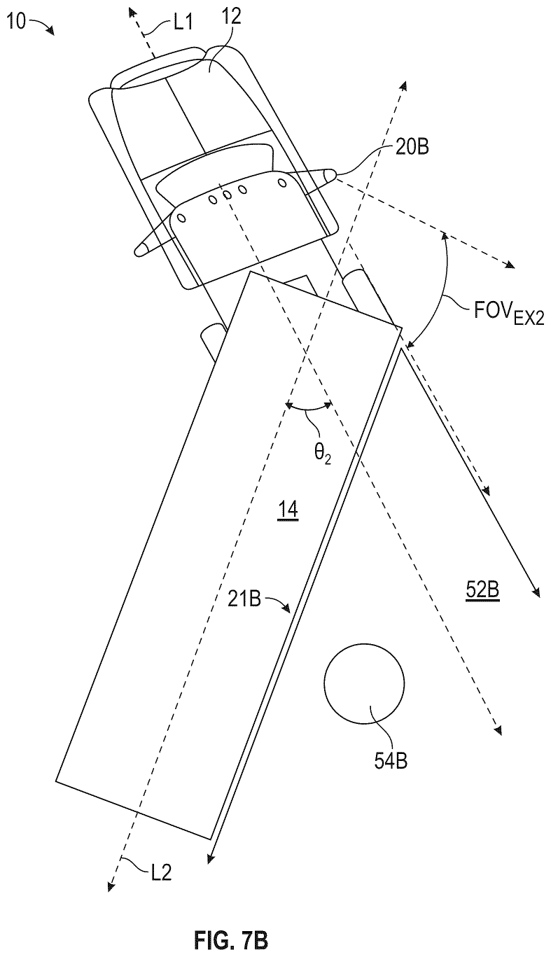

FIG. 7A is a schematic birds-eye view of a first example trailer angle θ₁ of approximately 50° formed between a central longitudinal axis L1 of the tractor 12 and a central longitudinal axis L2 of the trailer 14. The trailer angle θ₁ causes the first side 21A of the commercial vehicle 10, and an area 52A adjacent to the first side 21A of the commercial vehicle 10, to be outside the field of view FOV_{EX1} of camera 20A. Correspondingly, the trailer angle θ₁ also causes an object 54A in the area 52A to be outside of the field of view FOV_{EX1} of camera 20A. The size of the area 52A depends on the size of the trailer angle θ₁. However, the object 54A is in a field of view of the trailer camera 16C or 16C′ (see FIGS. 2-3).

FIG. 7B is a schematic birds-eye view of a second example trailer angle θ₂, also of approximately 50°, formed between the axes L1, L2. The trailer angle θ₂ causes the second side 21B of the commercial vehicle 10, and an area 52B adjacent to the second side 21B of the commercial vehicle 10, to be outside the field of view FOV_{EX2} of camera 20B. Correspondingly, the trailer angle θ₂ also causes an object 54B in the area 52B to be outside of the field of view FOV_{EX2} of camera 20B. The size of the area 52B depends on the size of the trailer angle θ₂. However, the object 54B is in a field of view of the trailer camera 16D or 16D′ (see FIGS. 2-3).

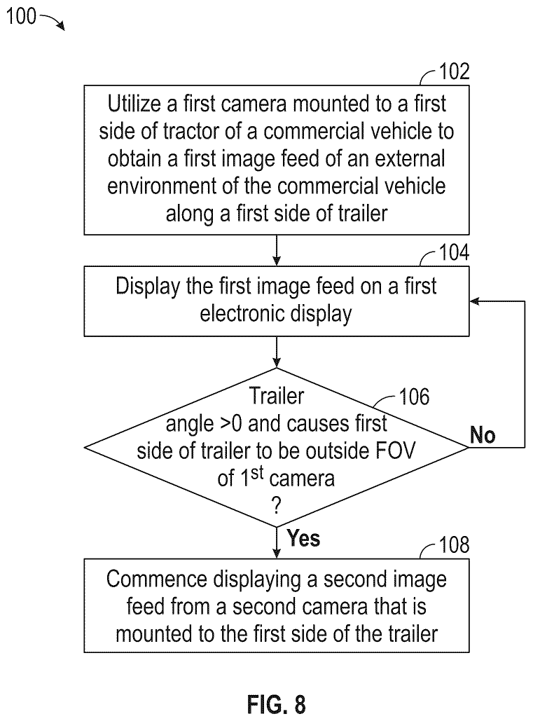

FIG. 8 is a flowchart of an example method 100 for a CMS 15. The method 100 may be performed by the ECU 22, for example. For the discussion below, the method 100 will be discussed in connection with cameras 20A and 20C/20C′.

A first camera 20A mounted to a first side of tractor 12 of a commercial vehicle 14 is utilized to obtain a first image feed of an external environment of the commercial vehicle along a first side 21A of a trailer 14 of the commercial vehicle 10 (step 102). The external environment may correspond to area 52A of FIG. 7A, for example. The first camera 20A has a field of view FOV_{EX1}.

The first image feed is displayed to an occupant of the commercial vehicle 10 on a first electronic display (step 104), which may be display 18A, for example.

The ECU 22 determines whether the commercial vehicle 10 has a non-zero trailer angle that causes the first side 21A of the trailer 14 to be outside of the field of view FOV_{EX1} (step 106).

If the ECU 22 determines in step 106 that the commercial vehicle 10 has a non-zero trailer angle (e.g., 10°) that causes the first side 21A of the trailer 14 to be outside of the field of view (a “yes” to step 106), the ECU 22 commences displaying a second image feed from a second camera 20C or 20C′ that is mounted to the trailer 14 (e.g., to the first side 21A of the trailer) to an occupant of the commercial vehicle 10 on the first electronic display (e.g., display 18A) or another electronic display (e.g., display 18C, 18D, or 18E). An example of a “yes” to step 106 is illustrated in FIG. 7A with trailer angle 01. In one or more embodiments, the ECU 22 performs image stitching of an image from a tractor camera (e.g., camera 20A and a trailer camera (e.g., camera 20C or 20C′) on one of the CMS displays (e.g., display 18A).

Based on the commercial vehicle 10 having a trailer angle of zero, or a non-zero trailer angle that does not cause the first side 21A of the trailer 14 to be outside a field of view of the first camera 20A (a “no” to step 106), the ECU 22 continues displaying the first image feed on the first electronic display (step 104) and does not commence displaying the second image feed from the second camera 20C or 20C′.

In one or more embodiments, the ECU 22 further bases the performance of step 108 on the commercial vehicle 10 being in reverse.

Although the discussion above focused on cameras 20A and 20C/20C′, it is understood that the method 100 could also be performed for cameras 20B and 20D/20D′ for the second side 21B of the trailer, to address the scenario depicted in FIG. 7B. In such an example, if the ECU 22 determines that the commercial vehicle 10 has a non-zero trailer angle angle θ₂ that causes the second side 21B of the trailer 14 to be outside of the field of view FOV_{EX2} of camera 20B, the ECU 22 commences displaying a second image feed from a second camera 20D or 20D′ that is mounted to the second side 21B of the trailer 14 in step 108.

Although example embodiments have been disclosed, a worker of ordinary skill in this art would recognize that certain modifications would come within the scope of the claims. For that reason, the following claims should be studied to determine their true scope and content.

1. A method for a camera monitor system (CMS), comprising:
utilizing a first camera mounted to a first side of a tractor of a commercial vehicle to obtain a first image feed of an external environment of the commercial vehicle along a first side of a trailer of the commercial vehicle;
displaying the first image feed on a first electronic display; and
based on the commercial vehicle having a non-zero trailer angle that causes the first side of the trailer to be outside a field of view of the first camera, commence displaying a second image feed from a second camera on the first electronic display or another electronic display, wherein the second camera is mounted to the trailer, and wherein the second image feed is of the external environment of the commercial vehicle along the first side of the trailer;
wherein a first field of view of the first camera and a second field of view of the second camera are both oriented to face rearwards towards a rear edge of the first side of the trailer.

2. The method of claim 1, wherein the second camera is mounted to the first side of the trailer.

3. The method of claim 1, wherein said commence displaying the first image feed from the second camera is further based on the commercial vehicle being in reverse.

4. The method of claim 1, wherein said commence displaying the second image feed from the second camera is further based on the non-zero trailer angle being at least 10°.

5. The method of claim 1, wherein the second camera is mounted to the trailer at a location that is closer to a front of the trailer than to a rear of the trailer.

6. The method of claim 1, wherein said commence displaying the second image feed from the second camera comprises commence displaying the second image feed on a second electronic display that is different from the first electronic display.

7. The method of claim 1, wherein said commence displaying the first image feed from the second camera comprises commence displaying the second image feed on the first electronic display.

8. The method of claim 1, comprising:
utilizing a third camera mounted to a second side of the tractor of the commercial vehicle to obtain a third image feed of an external environment of the commercial vehicle along the second side of the trailer, the second side of the trailer opposite to the first side of the trailer;
displaying the third image feed on a second electronic display; and
based on the commercial vehicle having a non-zero trailer angle that causes the second side of the trailer to be outside a field of view of the second camera, commence displaying a fourth image feed from a fourth camera on the second electronic display or another electronic display, wherein the fourth camera is mounted to the trailer, and wherein the fourth image feed is of the external environment of the commercial vehicle along the second side of the trailer;
wherein a third field of view of the third camera and a fourth field of view of the fourth camera are both oriented to face rearwards towards a rear edge of the second side of the trailer.

9. A camera monitor system (CMS), comprising:
a first camera mounted to a first side of a tractor of a commercial vehicle and configured to provide a first image feed of an external environment of the commercial vehicle along a first side of a trailer of the commercial vehicle;
a second camera mounted to the trailer and configured to provide a second image feed of the external environment along the first side of the trailer; and
processing circuitry operatively connected to memory and configured to:
display the first image feed on a first electronic display; and
based on the commercial vehicle having a non-zero trailer angle that causes the first side of the trailer to be outside a field of view of the first camera, commence display of the second image feed on the first electronic display or another electronic display;
wherein a first field of view of the first camera and a second field of view of the second camera are both oriented to face rearwards towards a rear edge of the first side of the trailer.

10. The CMS of claim 9, wherein the second camera is mounted to the first side of the trailer.

11. The CMS of claim 9, wherein the processing circuitry is configured to further base the commencement of display of the second image feed on the commercial vehicle being in reverse.

12. The CMS of claim 9, wherein the processing circuitry is configured to further base the commencement of display of the second image feed on the non-zero trailer angle being at least 10°.

13. The CMS of claim 9, wherein the second camera is mounted to the trailer at a location that is closer to a front of the trailer than to a rear of the trailer

14. The CMS of claim 9, wherein to commence display of the second image feed, the processing circuitry is configured to display the second image feed on a second electronic display that is different from the first electronic display.

15. The CMS of claim 9, wherein to commence display of the second image feed, the processing circuitry is configured to display the second image feed on the first electronic display.

16. The CMS of claim 9, wherein the second camera is part of a second camera arm that is rotatable between a first, retracted position, and a second, extended position.

17. The CMS of claim 9, comprising:
a third camera mounted to a second side of the tractor and configured to provide a third image feed of the external environment of the commercial vehicle along a second side of a trailer of the commercial vehicle, the second side of the trailer opposite to the first side of the trailer; and
a fourth camera mounted to the trailer and configured to provide a fourth image feed of the external environment along the second side of the trailer;
wherein the processing circuitry is configured to, based on the commercial vehicle having a non-zero trailer angle that causes the second side of the trailer to be out of a field of view of the third camera, commence displaying a fourth image feed from the fourth camera on the second electronic display or another electronic display, wherein the fourth image feed is of the external environment of the commercial vehicle along the second side of the trailer;
wherein a third field of view of the third camera and a fourth field of view of the fourth camera are both oriented to face rearwards towards a rear edge of the second side of the trailer.

18. The CMS of claim 9, wherein:
the processing circuitry is configured to perform image stitching of images from the first camera and the second camera to obtain a stitched image feed; and
to display the second image feed, the processing circuitry is configured to display the stitched image feed.

19. The method of claim 1, comprising:
performing image stitching of images from the first camera and the second camera to obtain a stitched image feed; and
said displaying the second image feed comprises displaying the stitched image feed.
